(19) United States
(12) Patent Application Publication
(10) Pub. No.: US 2002/0184825 A1
(43) Pub. Date: Dec. 12, 2002

(54) Apparatus for raising and lowering a vehicle window

(76) Inventor: Ekrem Ayran, Rothenbach A.D. Pegnitz (DE)

Correspondence Address: LERNER AND GREENBERG, P.A., Post Office Box 2480, Hollywood, FL, 33022-2480, US

(21) Appl. No.: 10/174,650

(22) Filed: Jun. 18, 2002

Related U.S. Application Data
(63) Continuation of application No. PCT/EP00/07505, filed on Aug. 3, 2000.

(30) Foreign Application Priority Data
Dec. 18, 1999 (DE) 199 61 268.4

(51) Int. Cl. E05F 11/38

(52) U.S. Cl. 49/348; 49/349

(57) ABSTRACT

The device raises and lowers a vehicle window pane solely by continuous path control without forced guidance. The device has a number of drive units which are operated by a continuous-path control unit with a programmable memory and which drive the vehicle window pane along a theoretical path over a barrel-shaped curved enveloping surface. The curved surface follows the external contours of the vehicle. The drive units used are preferably linear drives, which are controlled in an appropriate manner using trajectories projected onto the co-ordinate planes.

### CROSS-REFERENCE TO RELATED APPLICATION

This application is a continuation of copending International Application No. PCT/EP00/07505, filed Aug. 3, 2000, which designated the United States and which was not published in English.

### BACKGROUND OF THE INVENTION

1. Field of the Invention

The invention relates to an apparatus for raising and lowering a vehicle window. The apparatus has a number of drive units that displace the vehicle window on a barrel-curved envelope simulating the vehicle outer contour, in a Cartesian coordinate system. The x-axis extends along the vehicle longitudinal direction, the y-axis extends in the vehicle transverse direction, and the z-axis extends perpendicular to the plane defined by the x-axis and the y-axis. Such an apparatus is disclosed, for example, in U.S. Pat. No. 5,946,860 and German patent DE 195 04 781 C1. There, a vehicle window is understood, in particular, as a side window on the driver's or passenger's side of the vehicle that can be lowered into a vehicle door, or a rear window in the rear area, that can likewise be lowered into a vehicle door or into the vehicle body, the window being curved or bent in two directions.

Such a vehicle window can frequently be raised and lowered automatically by means of a window-lifting mechanism denoted below as a window lifter, this being done when, for this purpose, an operator simply actuates an appropriate toggle switch in the vehicle interior. Because of the currently customary streamlined and thus aerodynamically particularly favorable outer contour of vehicles, the side vehicle windows are also multiply curved, as a rule, and so their guidance for the production of a trouble-free movement cycle or withdrawal during raising and lowering is very complicated in terms of design. The corresponding statement holds for a backlite that can be raised and lowered automatically in the case of a station wagon, for example.

Thus, in the case of a design method, applied in practice, of the window lifter, the vehicle outer contour is simulated by a barrel-curved envelope with the aid of which the bending or curving course of the frame parts guiding the vehicle window is determined. The axes of a Cartesian coordinate system are fixed in the fictitious envelope simulating the outer contour of the vehicle at least in the region of the vehicle windows to be moved. In this case, the x-axis runs in the vehicle longitudinal direction, and the y-axis runs in the vehicle transverse direction, and the z-axis runs perpendicular to the plane defined by the x-axis and the y-axis. The x-axis points in the driving direction, and the y-axis points to the left seen by the driver sitting in the driving direction. The x-z-plane lies in the middle of the vehicle, the z-axis pointing downward.

Previous window lifters have been implemented as so-called cross-arm, cross-band or universal joint window lifters, or as so-called side window lifters. Whereas, for example, cross-arm window lifters known from German patent DE 28 43 300 C2 and from U.S. Pat. No. 4,221,079 are used predominantly for manual actuation, side window lifters known, for example, from European patent applications EP 0 064 135 A1 and EP 0 724 060 A1, and from German patent DE 44 28 262 C1, and a spindle drive, known from European patent application EP 0 490 341 A1, for a vehicle window are driven by electric motor. In the case of these prior art configurations, the vehicle window is positively guided between profiled strips and/or in guide links. An appropriate window guide with a particular design of guide rails of a double-track side window lifter is the subject matter of the above-mentioned U.S. Pat. No. 5,946,860 and German patent DE 195 04 781 C1 (also published PCT international application WO 96/25580), account being taken of the position of the vehicle window on the fictitious envelope. In order to withdraw, that is to say to lower and also to raise the rear window, path-guided window lifters with particularly complex mechanisms are provided in this case such as, for example, are disclosed in U.S. Pat. Nos. 3,646,707 and 4,121,381.

This type of positive guidance requires a substantial outlay on design and mounting techniques, the more so as it is necessary to provide appropriately bent or shaped guide rails or guide links whose radii of curvature or bending radii must firstly be designed according to the required path movement of the vehicle window. It is particularly difficult in this case to implement the exact guidance of a frameless vehicle window when, for example, in the case of a convertible there is no door frame for positively guiding the vehicle window moving upward out of the door or out of the vehicle body.

### SUMMARY OF THE INVENTION

It is therefore the object of the invention to specify a device for raising and lowering a curved vehicle window which, while avoiding the disadvantages, permits a movement that is as trouble-free as possible both in design terms and in a simple way as regards production engineering, that is to say permits the vehicle window to be withdrawn with as little trouble as possible, in particular even in the case of a frameless vehicle window.

With the above and other objects in view there is provided, in accordance with the invention, an apparatus for raising and lowering a vehicle window of a vehicle having a vehicle longitudinal direction and a vehicle transverse direction, and wherein a Cartesian coordinate system is defined with an x-axis parallel to the longitudinal direction, a y-axis parallel to the transverse direction, and a z-axis orthogonal to the x-axis and the y-axis. The apparatus comprises:

a plurality of drive units for displacing the vehicle window in coordinated movement along a barrel-curved envelope imaging a vehicle outer contour, the drive units being activated with a memory-programmable path control for driving the vehicle window along a prescribed desired path extending on the barrel-curved envelope;

the plurality of drive units including a first drive unit having a first drive axis extending substantially parallel to the z-axis, and a second drive unit having a second drive axis extending parallel to the y-axis of the envelope.

In other words, a programmable path control is provided that activates a number of drive units coupled to the vehicle window in such a way that the vehicle window moves on a prescribed desired path. The desired path corresponds in this case to the withdrawal direction or the course of withdrawal along a barrel-curved envelope simulating the respective vehicle outer contour.

The invention proceeds in this case from the consideration that the outlay on the design and, in particular, the application and production of a window lifter can be reduced by moving the vehicle window without positive guidance and, in particular, merely with path control and without cable and cross-band. Movement is expediently performed under numerical control along a prescribed (desired) path, whose path points forming this path are determined by coordinates defining the respective location in space.

The invention is also based on the finding that a three-dimensional path course of a vehicle window can be implemented by a coordination of individual movements in the fundamental planes of a Cartesian coordinate system. The two-dimensional path courses, comparatively easy to master in control terms, in the fundamental planes can be determined, in turn, from a projection of the desired path onto the respective fundamental plane, and this corresponds in programming terms to a transformation of the desired path coordinates into the plane coordinates that can be calculated with mathematical precision. The individual movements in the fundamental planes can be implemented solely by linear drives, which can be activated easily and—by comparison with a multi-jointed arm—can also be mastered easily in programming terms. The overall movement resulting from the coordinated individual movements thus corresponds to the desired path along which the vehicle window moves.

Thus, use is advantageously made as drive units only of linear drives that can be operated electrically, pneumatically or else hydraulically. A pneumatic operation is suggested in the case of vehicles with pneumatic central locking, since the required units are already present there.

The desired path, running in a curved fashion in space because of the barrel-curved envelope, of the vehicle window, which is likewise curved, in consequence, can be defined by an arbitrary number of points whose (Cartesian) coordinates are determined in the coordinate system referred to the envelope. In order to implement the withdrawal course, corresponding to the desired path, of the vehicle window, use is made of a number of drive units whose drive axes correspond to the three translatory degrees of freedom of the vehicle window in the direction of the x-, y- and z-axes, and to the three rotational degrees of freedom about these three axes.

A movement or displacement of the vehicle window upward or downward is expediently implemented in this case by a first linear drive whose drive axis runs in the direction of the z-axis. drive unit in the form, in turn, of a linear drive whose drive axis is also moved by the drive axis running in the z-direction. The corresponding drive unit then expediently acts on the lower edge of the window.

These two linear drives controlled by the path control with the aid of programmed parameters already provide a combined and coordinated movement of the vehicle window along the first drive axis, running at least approximately parallel to the z-axis of the envelope, and the second drive axis, running parallel to the y-axis of the envelope. Consequently, these two drives can be used to move the vehicle window already in the z-direction, that is to say in the withdrawal direction upward and downward, as well as simultaneously in the y-direction, that is to say laterally to and fro. Suitable parameters for activating the drive units are, in particular, the drive speed and the respective activation time, that is to say the starting instant and the duration of an activating pulse generated with the aid of corresponding manipulated variables of the path or drive control.

A further drive unit can be provided for a movement in the direction of the x-axis. The movement in the direction of the x-axis is expediently substituted by virtue of the fact that the drive unit active in the direction of the z-axis is set up correspondingly in the xz-plane and runs obliquely to the z-axis in this case. This substitution is therefore expedient simply in that in practice the movement in the direction of the x-axis is a displacement in the range of a few millimeters or a few centimeters that is only slight by comparison with the path distance covered in the z-direction.

A further drive unit with a rotary action can be provided in order to implement a rotary movement of the vehicle window about the z-axis. However, this rotary movement about the z-axis is also expediently substituted. For this purpose, the first drive axis is preferably formed from two parallel axes spaced apart from one another in the direction of the x-axis of the envelope, and which run correspondingly offset from one another along the z-axis in the direction of the y-axis. If the two drive axes, expediently implemented in turn by linear drives, travel at different speeds during their movement in the direction of the z-axis, a rotary movement about the y-axis is simultaneously implemented.

A further drive unit, which preferably acts directly on the lower edge of the window, effects a rotation of the vehicle window about the x-axis in such a way that the upper edge of the window swivels in the direction of the vehicle interior, and is thereby pressed against an upper window seal. The third drive unit, advantageously embodied by at least one linear drive, is expediently also moved in this case by the second of the two drive axes running orthogonally relative to one another, and is also moved, for its part, by the first drive unit. The linear drive representing the third drive unit acts for this purpose on the lower edge of the vehicle window, the latter thereby expediently being held in a fashion capable of swiveling.

The third drive unit can also be implemented by two linear drives that are arranged one above another and act on two points lying one over another at the lower edge of the window. In the case of this drive configuration, the second drive axis can be eliminated, since a movement in the y-direction can be implemented by these two linear drives, which are then also moved by the first drive axis. If the two linear drives travel in the direction of the y-axis, doing so to different distances, the translatory movement in the y-direction and, subsequently, a rotary movement about the x-axis are achieved.

A particularly advantageous drive configuration comprises two drive axes that are spaced apart from one another in the x-direction and of which each supports two linear drives arranged one over another and acting on the lower edge of the window at points lying one above another. It is possible to use this drive configuration to implement a movement of the vehicle window with all six degrees of freedom in a simple way, and this is of substantial advantage, in particular, for the desired path of a rear window, which is usually multiply curved.

In this case, the translatory movements in the z- and x-directions can be implemented simultaneously by obliquely positioning the drive axes in the direction of the z-axis. The rotary movement about the y-axis is achieved by driving these two drive axes at different speeds. If, in addition, the linear drives arranged in pairs one above another are driven synchronously in the y-direction and, in the process, to different distances in pairs, as well as with a different speed in the direction of the y-axis, the translatory movement in the y-direction and, at the same time, the rotary movements about the x-axis and about the z-axis are achieved.

It is expedient for the path control to comprise a programmable processor into which the preferably Cartesian coordinates of the points describing the desired path are or can be input. The processor is expediently connected on the output side to a control device which is, for its part, connected on the output side to the corresponding drive units. The control device is expediently designed as an open control circuit that supplies the corresponding control signals for the individual drive units. The control circuit can, however, also be designed as closed, and thus as a closed-loop control circuit, in order to correct deviations in the actual movement of the desired path.

The control device uses the points of the desired path that are defined by the Cartesian coordinates to define corresponding controlled or reference variables for the or each drive unit. The determination of the controlled variables is expediently performed in this case with the aid of a coordinate transformation corresponding to the projection of the three-dimensional desired path onto the xy-plane, xz-plane and/or yz-plane, and a rotation about the or each coordinate axis. These transformed coordinates thus form two-dimensional path courses in the respective plane. The individual points constituting these transformed (two-dimensional) path courses within the respective plane are approached at the respectively determined instant by the respective drive axis at the speed determined by the control device. In this case, the respective drive unit is activated by means of the manipulated variable derived from the (transformed) coordinates of the path running in the x-y-plane, in the z-x-plane and/or in the z-y-plane in such a way that the overall movement of the vehicle window resulting from the individual movements of the drive axes runs along the desired path.

The advantages achieved with the invention consist, in particular, in that, as a result of providing a programmable or numerical control for a number of drive units that drive a vehicle window on a prescribed desired path, the vehicle window is raised and lowered only under path control, and thus without positive guidance. The apparatus provided for this purpose permits the movement sequence of a curved vehicle window to be adapted in a simple way to an arbitrary barrel-curved envelope by simply programming into the path control coordinates that have been determined once for the points describing the corresponding desired path. The path control then uses these coordinates to determine the respective manipulated or reference variables for the individual drive units in a preferably open control circuit.

In accordance with an advantageous embodiment of the invention, only linear drives are used for the path-controlled movement of the vehicle window along the desired path. It is also possible to master complex drive configurations in terms of programming and control technique by suitably activating the linear drives individually, be performing the programming and control by imaging or projecting the desired path onto the fundamental planes of the Cartesian coordinate system by means of corresponding coordinate transformation.

Particularly in relation to a multi-jointed arm with a plurality of rotary drives, it is possible by using linear drives to implement different drive configurations for various path movements in the manner of the modular principle or a modular design. Particularly in conjunction with an activation of the linear drives with the aid of path courses projected into the fundamental planes, this is, on the one hand, advantageous for the path control of a rear window along a complicated desired path. On the other hand, this permits the provision of a multiplicity of identical parts for simple and timesaving adaptation of the respective drive configuration to different vehicle outer contours. The programmable path control also permits a particularly simple and timesaving correction of manufacturing tolerances by inputting data on the spot, that is to say at the already produced vehicle. Finally, virtually any window movement can be implemented, particularly also in the case of new concepts for doors or seals.

Other features which are considered as characteristic for the invention are set forth in the appended claims.

Although the invention is illustrated and described herein as embodied in an apparatus for raising and lowering a vehicle window, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a barrel-curved fictitious envelope with, in the upper half surface, a curved side and rear window of a vehicle, as well as the coordinates of individual points of desired paths of the two vehicle windows,

FIG. 2 shows a first drive configuration with a linear drive moved in conjunction with two mutually orthogonal drive axes,

FIG. 3 shows a second drive configuration with two linear drives guided along a common drive axis,

FIG. 4 shows a third drive configuration with two drives designed in accordance with FIG. 3,

FIGS. 5a-5c show the path course of the side window and projection thereof onto the zx- or zy-plane of a Cartesian coordinate system, and

FIGS. 6a-6c show the path course of the rear window, as well as the projection thereof onto the zx- or zy-plane of a Cartesian coordinate system.

Corresponding parts are provided in all figures with the same reference symbols.

### DESCRIPTION OF THE PREFERRED EMBODIMENTS

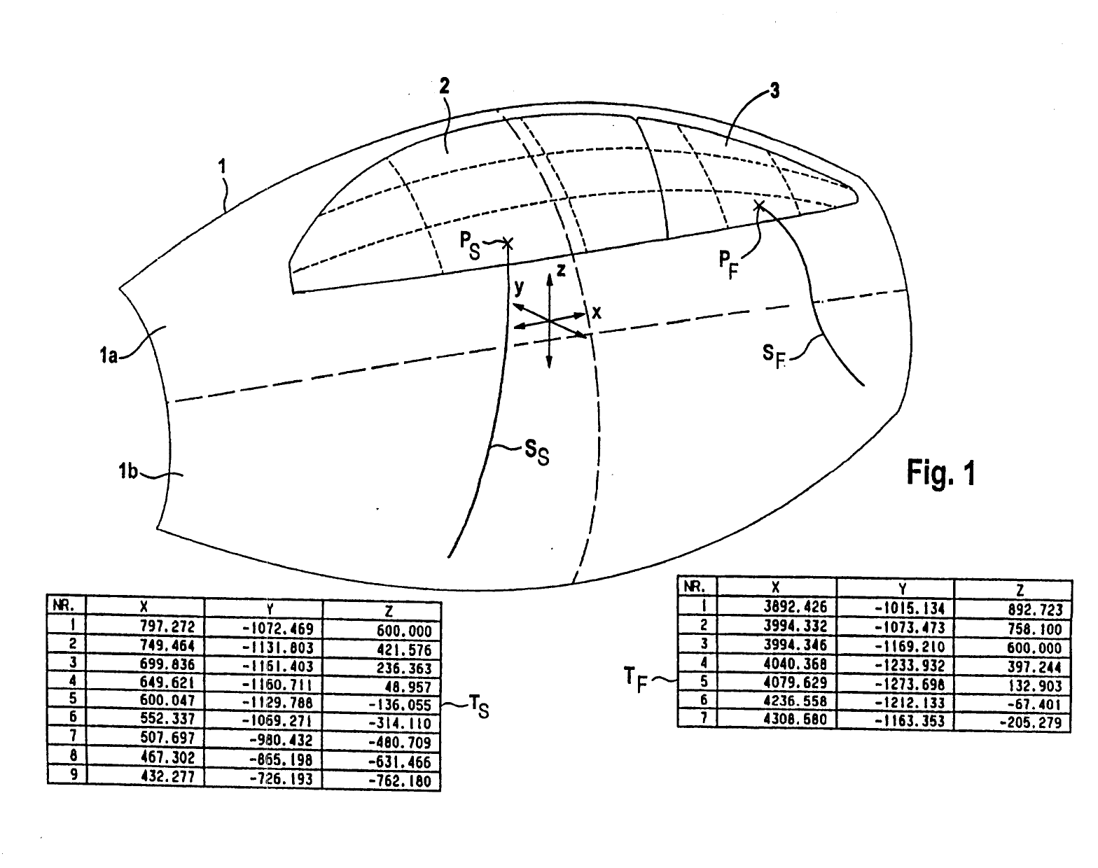

Referring now to the figures of the drawing in detail and first, particularly, to FIG. 1 thereof, there is shown a barrel-curved envelope 1 that simulates the outer contour of a vehicle (not illustrated in more detail), in particular of an automobile. Referred to the illustrated Cartesian coordinate system x, y, z, vehicle windows 2, 3 curved both in the z-direction and in the x-direction may be seen on the upper half surface 1a of the envelope 1. These are the side window 2 and rear window 3 on the driver's side which, when being raised and lowered, are to travel along the desired paths Ss and SF, respectively, running as far as into the lower half surface 1b of the envelope 1.

The desired path S_{S} of the side window 2 is described by nine points that are presented in the column denoted by NR of the table Ts illustrated at the bottom left of FIG. 1. The associated x-, y- and z-coordinates are presented in the further columns of this table T_{S}. The coordinates given there by example relate to the coordinate system x, y, z conventionally situated in the middle of the vehicle. The corresponding table T_{F} with seven points representing the desired path SF is illustrated at the bottom on the right of FIG. 1. Since it is known that in the case of the definition of kinematics of a vehicle window 2, 3 the channel seal has proved to be particularly advantageous as initial position for the definition of the desired path S_{S}, S_{F}, the respective starting or initial point P_{S}, P_{F} is positioned within the envelope 1 in the region of the virtual channel seal in the case of the exemplary embodiment, as well.

The initial point P_{S}, P_{F} selected in the exemplary embodiment is one of a plurality of possible initial points, and is used to determine the respective desired path S_{S} or S_{F} and the coordinates x, y, z thereof. Thus, it is also possible to select a point in the region of the upper right-hand window corner, a point in the region of the lower left-hand window corner and/or a point in the region of the lower right-hand window corner, wherein case the latter should then lie on the virtual line represented by the window seal.

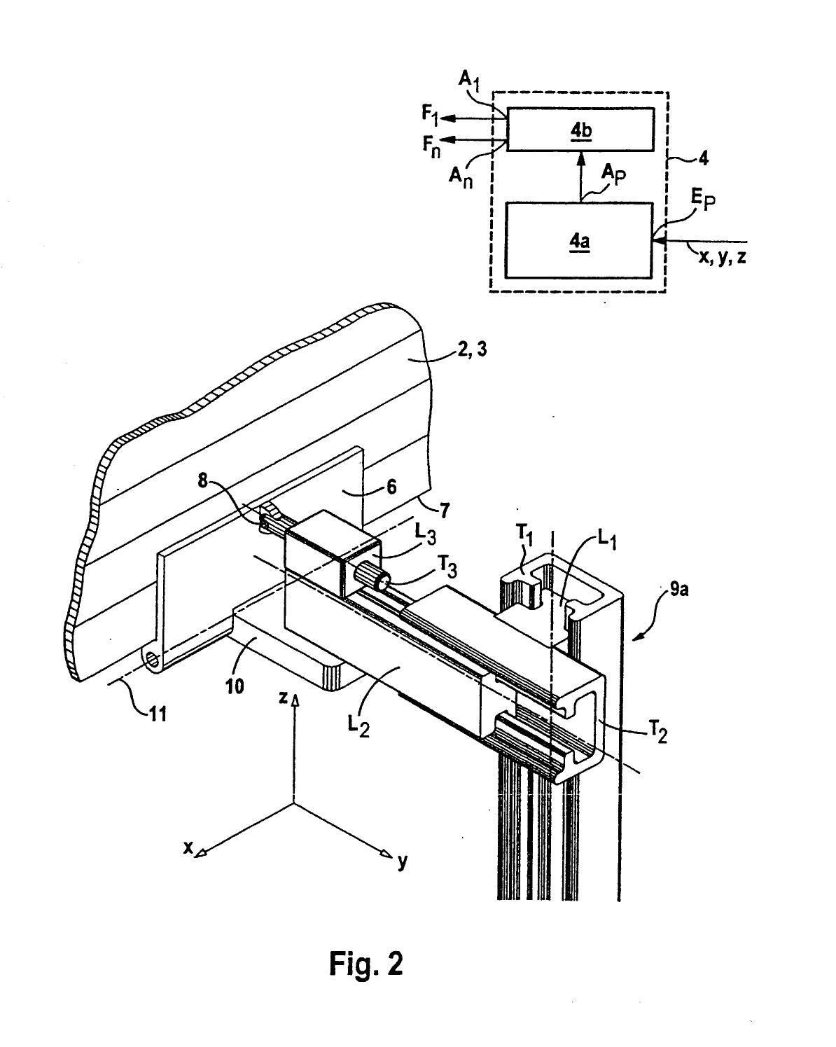

The coordinates x, y, z representing the individual points of the respective desired path S_{S}, S_{F} are input via a data input E_{P} into a programmable processor 4a of a path control 4 illustrated schematically in FIG. 2. Connected on the input side to a processor output A_{P} of the processor 4a is a control device 4b that has a number of control outputs A₁ to Aₙ that can be connected to drive units. The drive units are designed as linear drives Lₙ in the exemplary embodiments in accordance with FIGS. 2 to 4. The linear drives Lₙ have corresponding control inputs to which the respective control output Aₙ of the path control 4 can be connected in a way not shown in more detail. In order to control the individual linear drives L_{1 . . . n}, the control device 4b generates appropriate controlled or reference variables F_{1 . . . n}, that are determined by the path control 4 with the aid of the respective desired path S_{S}, S_{F} as well as from the approach speeds v and the approach instants t, which are to be used to approach, or to be approached by, the individual points (x, y, z) on the desired path S_{S}, S_{F}.

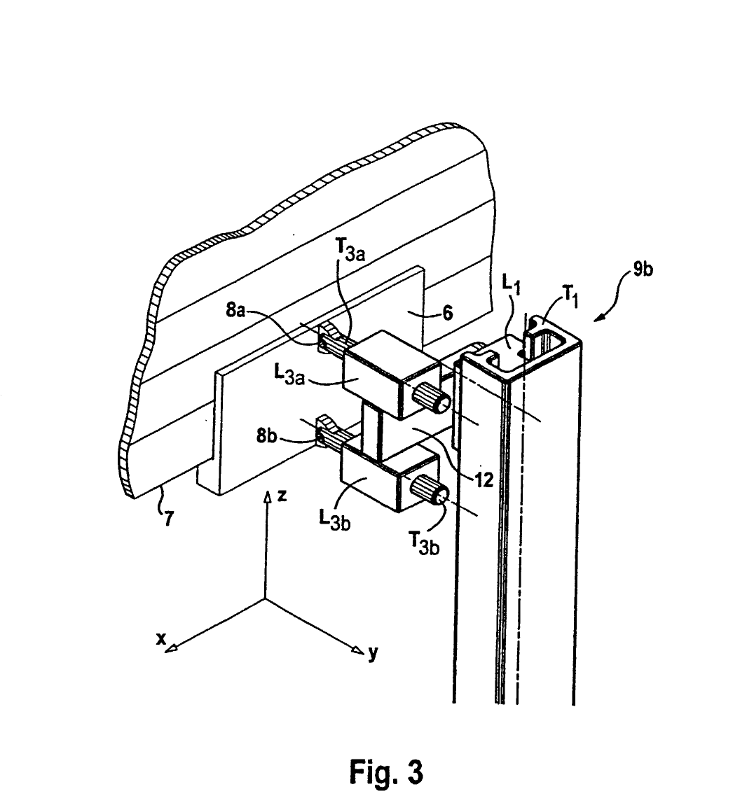

The vehicle window 2, 3 illustrated in detail in FIGS. 2 and 3 is held on a mounting rail 6 that supports the vehicle window 2, 3 at the lower edge 7 thereof, and is held at said edge, preferably adhesively. Acting on this mounting rail 6 is a drive unit in the form of a linear drive L₃, of which the drive axis Tₐ, running in the direction of the y-axis, is pivoted at its free end to the mounting rail 6 via a swivel joint 8.

The linear drive L₃ is part of a drive configuration 9a having a total of three linear drives L₁ to L₃. The drive axis T₁ of the linear drive L₁ runs in the direction of the z-axis, while the drive axis T₂ of the second linear drive L₂, also moved by the first linear drive L₁, runs in the direction of the y-axis. The linear drives L_{1,2} and their drive axes T_{1,2} are implemented in the exemplary embodiment by profiled rails, the drive axis T₁ of the linear drive L₁ being held fixed in position for example in a vehicle door (not illustrated).

By means of the programmable path control 4, the linear drives L₁ to L₃ are activated with the aid of the coordinates x, y, z representing the respective desired path S₂ or S₃ in such a way that an overall movement of the vehicle window 2, 3 corresponding to the desired path S_{2,3} results from coordinated movement of the drive axes T₁ to T₃. The principal movement is performed in this case by means of the linear drive L₃ along the drive axis T₁ in the direction of the z-axis. The speed v₁ of the movement, and the instants t at which the linear movement of the drive axes T₁ is started and stopped are parameters prescribed by the path control 4 in this case. Simultaneously, or else with a time offset, there is a linear movement of the drive axis T₂ at a likewise prescribed speed v₂ in the direction of the y-axis by the linear drive L₂. At an instant t, which can likewise be prescribed by the path control 4, and at a prescribed speed V₃, there is a linear movement along the drive axis T₃ by means of the linear drive L₃ in the direction of the y-axis. This linear movement results in a rotational movement of the vehicle window 2, 3 about the x-axis. This is achieved, moreover, by the pivoted holding of the drive axis T₃ on the mounting rail 6 and, on the other hand, by the fact that it is supported in a guide plate 10, also moved by the linear drive L₂, such that it can rotate about a swiveling axis 11.

In this drive configuration 9a in accordance with FIG. 2, the linear drive L₁ therefore also moves the linear drive L₂ that supports the linear drive L₃ and supports the vehicle window 2, 3 via the profile strip 6 in the region of the lower edge 7 of the window.

An alternative drive configuration 9b is shown in FIG. 3. In this case, the drive axis T₁ running in the direction of the z-axis, and the linear drive L₃ are designed in accordance with the exemplary embodiment according to FIG. 2. By contrast with the exemplary embodiment in accordance with FIG. 2, in this drive configuration 9 the linear drive L₁ also moves two linear drives L₃ₐ and L_{3b} designed in accordance with the linear drive L₃ according to FIG. 2. For this purpose, these two linear drives L₃ₐ and L_{3b} arranged one above another are held on a common mounting plate 12 that is fitted on the linear drive L₁ and is thus moved along the drive axis T₁.

A translatory movement of the vehicle window 2, 3 in the direction of the z-axis is performed, in turn, by the drive axis T₁ by means of the linear drive L₁. A translatory movement of the vehicle window 2, 3 in the direction of the y-axis is performed by synchronous movement of the two drive axes T₃ₐ and T_{3b} of the linear drives L₃ₐ and L_{3b}, respectively. The drive axes T₃ₐ, T_{3b} are connected in turn in a swiveling fashion via a swivel joint 8a, 8b in each case to the mounting rail 6 embracing the lower edge 7 of the vehicle window 2, 3. A linear movement of the two drive axes T₃ₐ and T_{3b} at different speeds in the direction of the y-axis then results in a rotary movement of the vehicle window 2, 3 about the x-axis. On the one hand, in the case of withdrawal in the direction of the z-axis the rotary movement about the x-axis follows up or lays the vehicle window 2, 3 on the envelope 1. On the other hand, in the raised and closed position of the vehicle window 2, 3 the latter can be pressed against, or lifted on a window seal (not illustrated) provided in the upper door frame region or roof edge region of the vehicle.

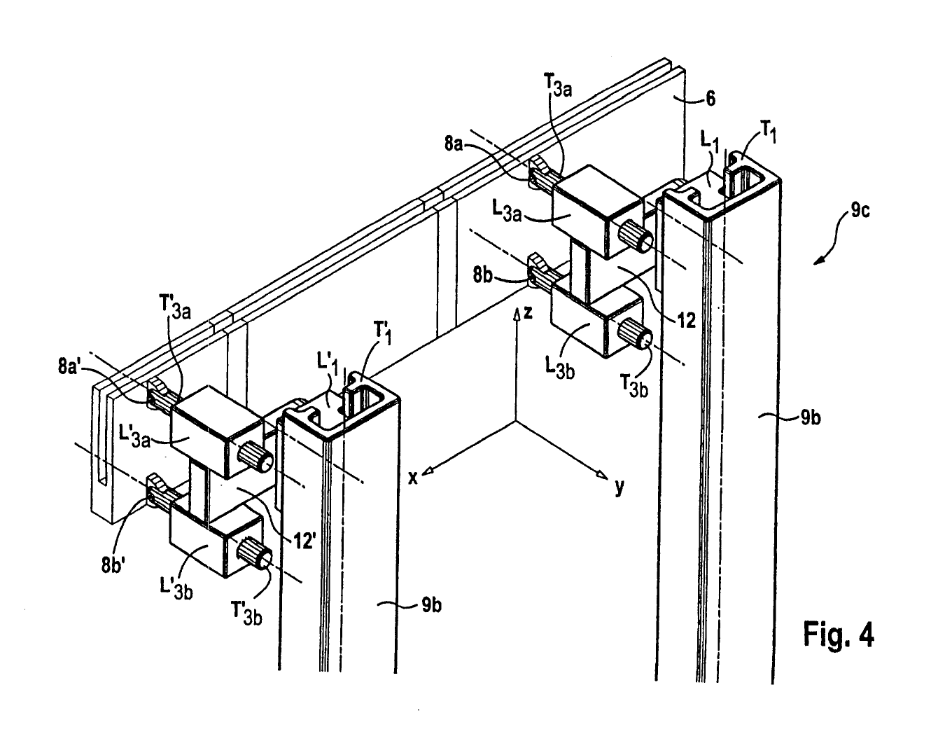

A drive configuration 9c that is particularly suitable for raising and lowering the front window 3, in particular, is shown in FIG. 4, the mounting rail 6 provided for holding vehicle window 2, 3 (not illustrated) once again being designed in a u-shaped fashion. The drive configuration 9c is formed from two drive configurations 9b in accordance with FIG. 3. The drive axes T₁ and T′₁ can be inclined by the amount Ax in the zx-plane. As a result, during a linear movement of the two drive axes T₁ and T′₁ a translatory movement of the vehicle window 2, 3 in the direction of the x-axis is simultaneously achieved. This economizes on additional linear drives for a translatory movement of the vehicle window 2, 3 in the direction of the x-axis. Two parallel or drive axes T₁, T′₁ are also arranged offset from one another by the amount Δy in the zy-plane, were they to move in the direction of the z-axis there would simultaneously be a rotary movement on the vehicle window 2, 3 about the z-axis.

With the aid of this drive configuration 9c, once again having only linear drives L₁, L₃ₐ, L_{3b} and L′₁, L′₃ₐ, L′_{3b}, it is possible to implement virtually all six degrees of freedom required for moving the vehicle window 2, 3 in space. Thus, the two drive axes T₁ and T′₁, which are spaced apart from one another and are preferably inclined by the amount Ax in the zx-plane as well as expediently running parallel to one another, serve to move the vehicle window 2, 3 in the direction of the z-axis in conjunction with movement in the direction of the x-axis as a consequence of the inclined position of the two drive axes T₁ and T′₁. In order to move the vehicle window 2, 3 in the direction of the y-axis, the drive axes T₃ₐ, T_{3b} and T′₃ₐ, T′_{3b}, also moved, in turn, by these drive axes T₁ and T′₁, are moved in the y-direction.

If the drive axes T₃ₐ and T_{3b}, on the one hand, and the drive axes T′₃ₐ and T′_{3b}, on the other hand, move at a different speed and by different amounts Δy, the vehicle window 2, 3 executes a rotary movement about the z-axis. If, in addition, the drive axes T₃ₐ and T′₃ₐ, on the one hand, and the drive axes T_{3b} and T′_{3b}, on the other hand, move at different speeds and by different amounts Δy, these linear movements result in a rotary movement of the vehicle window 2, 3 about the x-axis. A rotary movement of the vehicle window 2, 3 about the y-axis is achieved by virtue of the fact that the drive axes T₁ and T′₁ move with different speeds and by different amounts Δz.

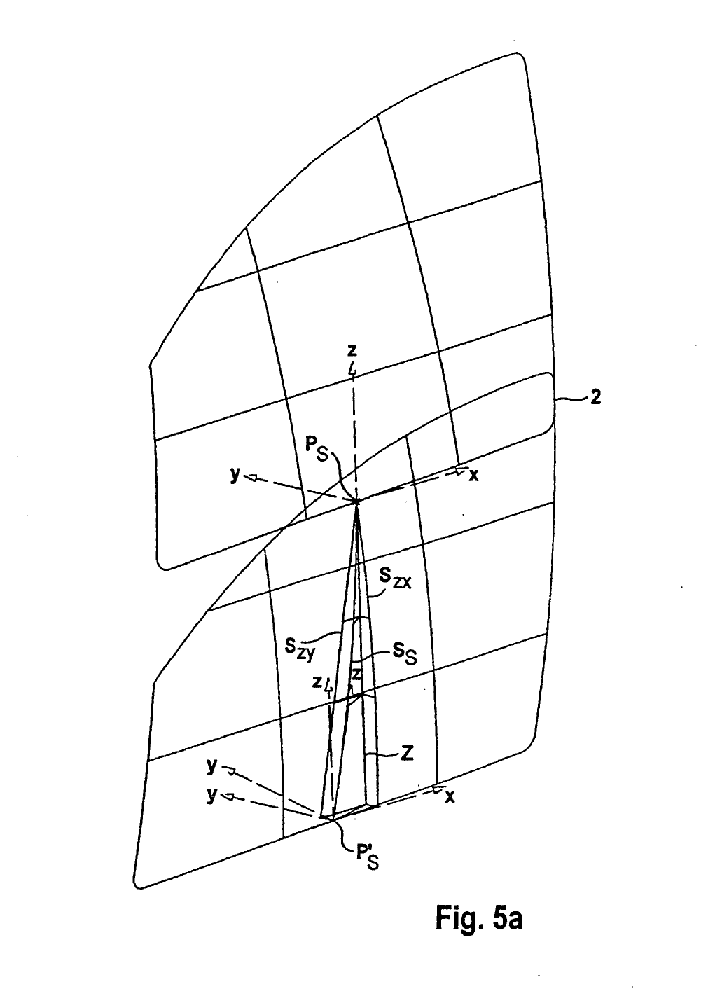

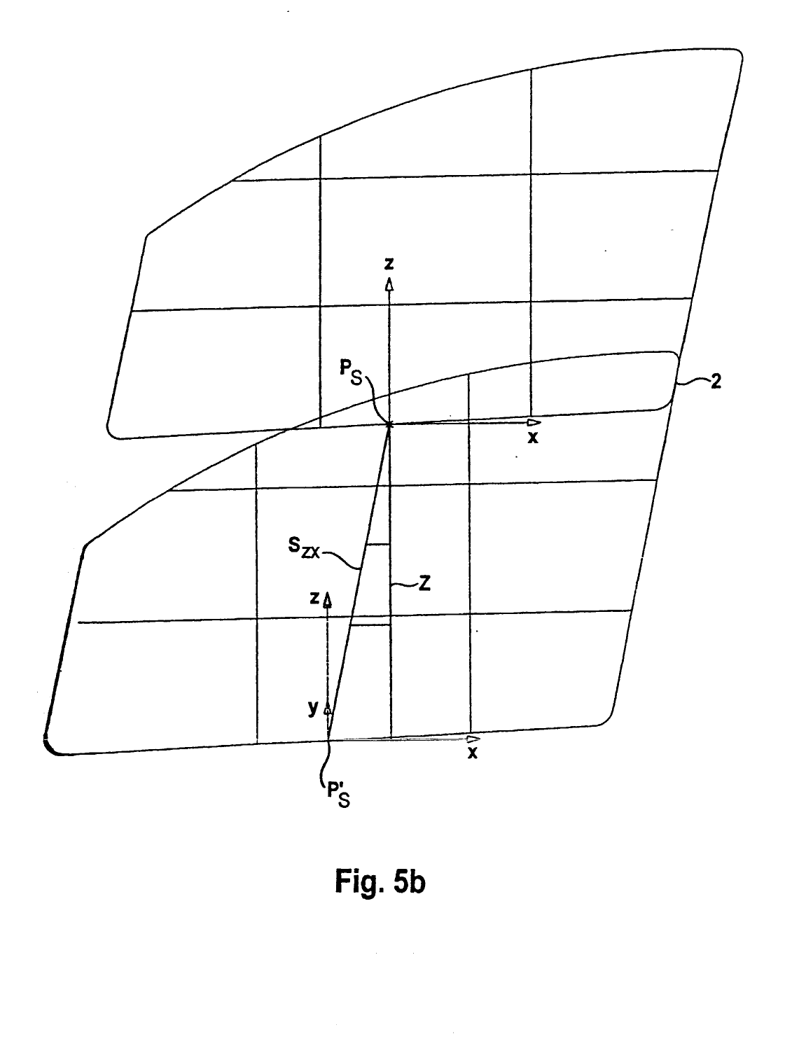

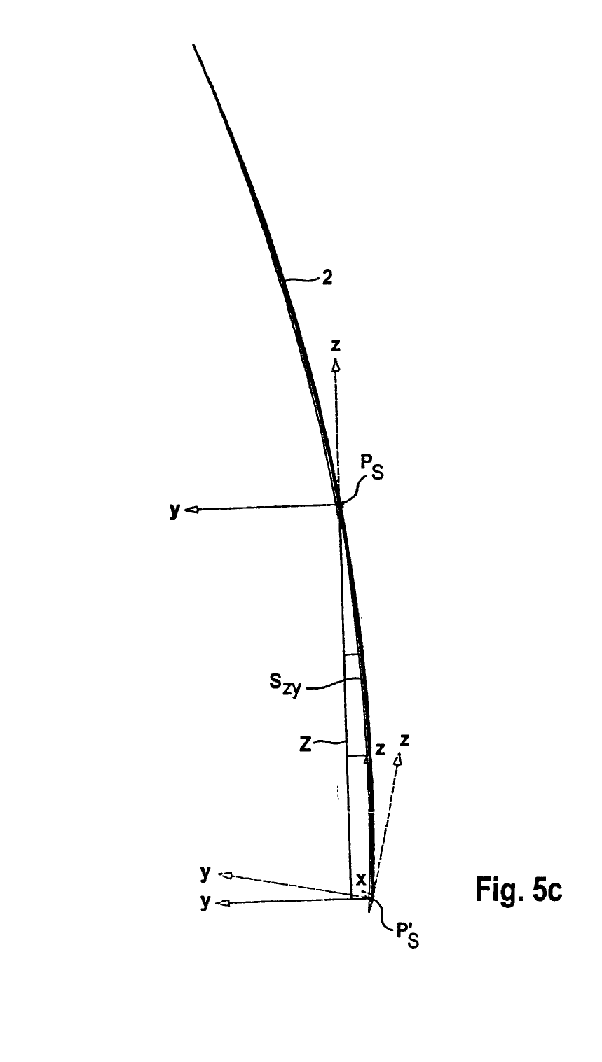

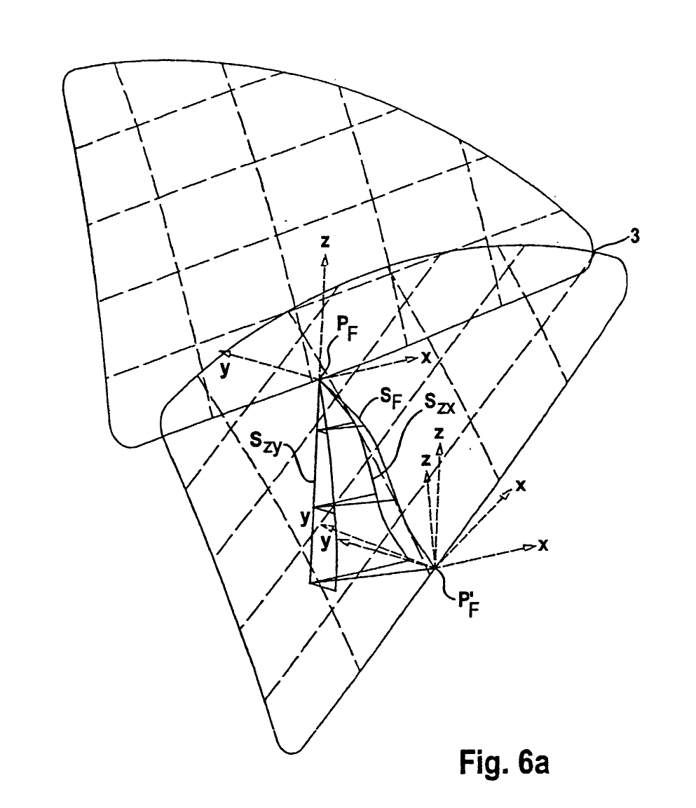

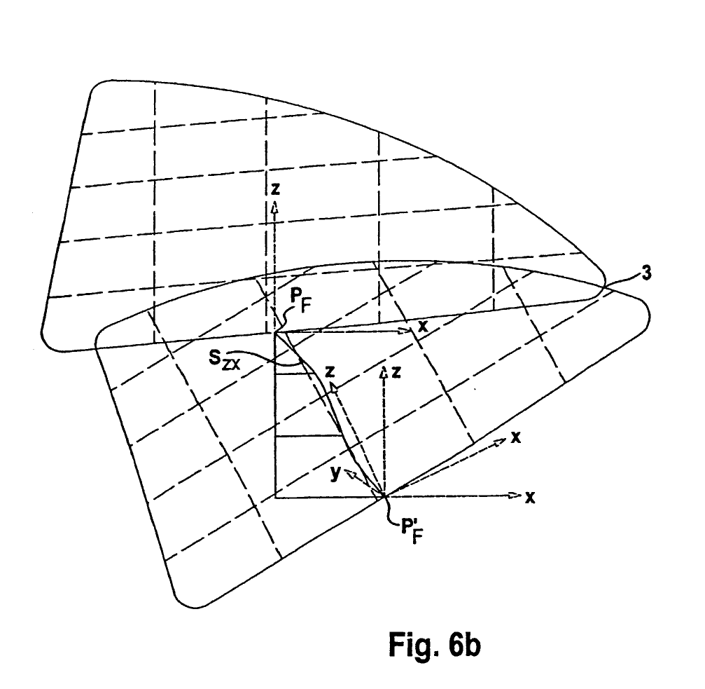

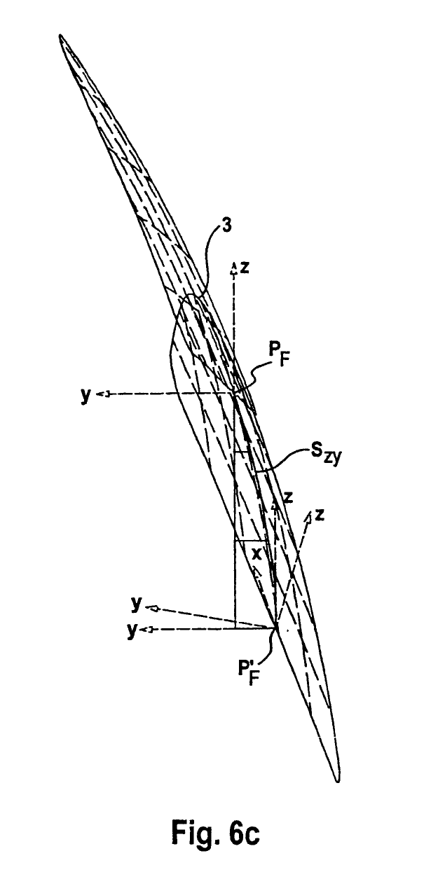

In order to produce the overall movement, running along the desired paths S_{S}, S_{F}, of the vehicle window 2, 3, it is advantageous firstly to make use under programmed control of the individual movements within the three fundamental planes zx, zy and xy of the Cartesian coordinate system x, y, z. This is illustrated for the side window 2 in FIGS. 5a to 5c, and for the rear window 3 in FIGS. 6a to 6c.

Thus, FIG. 5a shows the side window 2 in its raised and therefore closed upper position, on the one hand, and in its lowered and therefore open lower position, on the other hand. The initial coordinate system x, y, z lies at the upper initial point P_{S}, while the coordinate system x, y, z rotates about the y-axis by an amount Δy during the withdrawal or lowering of the vehicle window 2, 3 along the desired path S_{S} is illustrated in addition at the end point P'_{S}. Also illustrated are the path courses S_{xz}, S_{yz} and S_{xy}, which are projected onto the fundamental planes xz, zy and xy, and are thus two-dimensional, of the three-dimensional desired path S_{S}. The corresponding views in the planes xz and yz with the path courses S_{xz} and S_{yz}, respectively, are illustrated in FIGS. 5b and 5c.

FIG. 6a shows the back window 3 in the raised and in the lowered position, as well as the corresponding path courses of the S_{F}, S_{zx}, S_{yz}, while the path course S_{xz} and S_{yz} resulting from the respective projection of the desired path S_{F} into the zx- and zy-planes is illustrated in FIGS. 6b and 6c respectively.

The path control 4 uses these coordinates x, y, z, resulting through coordinate transformation from the desired path S_{S}, S_{F}, within the fundamental planes zx, zy and xy, to determine the respective controlled or reference variables F_{1 . . . n} for the individual linear drives L_{1 . . . n}. The individual drive axes T_{1 . . . n} approach the points in the fundamental planes of the coordinate system x, y, z with the aid of these reference variables F_{1 . . . n}. In this case, the individual movements are coordinated in such a way that their combination produces the overall movement of the vehicle window 2, 3 along the desired path S_{S} or S_{F}.

The drive configurations 9a, 9b and 9c with the respective drive units Lₙ, Tₙ and the path control 4 serving to activate the latter therefore form an apparatus for raising and lowering a vehicle window 2, 3 as a vehicle window lifter that has no positive guidance and only path control.

I claim:

1. An apparatus for raising and lowering a vehicle window of a vehicle having a vehicle longitudinal direction and a vehicle transverse direction, and wherein a Cartesian coordinate system is defined with an x-axis parallel to the longitudinal direction, a y-axis parallel to the transverse direction, and a z-axis orthogonal to the x-axis and the y-axis, the apparatus comprising:
a plurality of drive units for displacing the vehicle window in coordinated movement along a barrel-curved envelope imaging a vehicle outer contour;
a memory-programmable path control for activating said drive units for driving the vehicle window along a prescribed desired path extending on the barrel-curved envelope;
said plurality of drive units including a first drive unit having a first drive axis extending substantially parallel to the z-axis, and a second drive unit having a second drive axis extending parallel to the y-axis of the envelope.

2. The apparatus according to claim 1, which further comprises a third drive unit for generating a rotary movement of the vehicle window about the x-axis of the envelope.

3. The apparatus according to claim 2, wherein said third drive unit is disposed to be moved by one of said first drive unit and said second drive unit.

4. The apparatus according to claim 1, wherein said first drive axis is formed from two parallel axes placed apart from one another in the direction of the x-axis of the envelope.

5. The apparatus according to claim 4, wherein, for generating a rotary movement of the vehicle window about the z-axis, said two parallel axes run correspondingly offset from one another along the z-axis in the direction of the y-axis.

6. The apparatus according to claim 1, wherein said first drive axis extends obliquely to the z-axis within a plane of the envelope defined by the x-axis and the y-axis.

7. The apparatus according to claim 1, wherein each of said drive units is a linear drive.

8. The apparatus according to claim 7, which comprises a first linear drive having a drive axis in the direction of the z-axis, a second linear drive having a drive axis in the direction of the y-axis and being moved by said first drive axis, and a third linear drive being moved by said second drive axis and acting at a lower edge of the vehicle window on a swivel joint, for rotating the vehicle window about the x-axis.

9. The apparatus according to claim 7, wherein a linear drive, having a drive axis extending in the direction of the z-axis, supports two linear drives acting at a lower edge of the vehicle window on swivel joints lying one above another.

10. The apparatus according to claim 7, wherein two linear drives, having drive axes spaced apart from one another in the direction of the x-axis, each supports two linear drives acting at a lower edge of the vehicle window on swivel joints lying one above another.

11. The apparatus according to claims 1, wherein said path control includes a programmable processor with an input for inputting coordinates of individual points describing the desired path, and a control device connected to an output of said programmable processor and having a plurality of control outputs respectively connected to said drive units.

12. The apparatus according to claim 1, wherein said path control is configured to determine appropriate control parameters for each drive unit in accordance with the desired path.

13. The apparatus according to claim 12, wherein said path control is configured to derive the control parameters from a projection of the desired path onto one of three fundamental planes of the Cartesian coordinate system, the respective said drive unit is activated by the control parameter, derived from the coordinates of the path running in one of the x-y-plane, in the z-x-plane, and the z-y-plane such that an overall movement of the vehicle window resulting from the individual movements of the drive axes runs along the desired path.
